(19) United States
(12) Patent Application Publication
(10) Pub. No.: US 2013/0096699 A1
(43) Pub. Date: Apr. 18, 2013

(54) ASSET HEALTH MONITORING

(71) Applicants: Srini Sundaram, Chennai (IN); Ken McDonald, Oxford (GB)

(72) Inventors: Srini Sundaram, Chennai (IN); Ken McDonald, Oxford (GB)

(73) Assignee: OPTIMIZED SYSTEMS AND SOLUTIONS LIMITED, Derby (GB)

(21) Appl. No.: 13/704,110

(22) PCT Filed: Jun. 7, 2011
(86) PCT No.: PCT/EP11/59382

§ 371 Date: Dec. 13, 2012

(30) Foreign Application Priority Data
Jun. 21, 2010 (GB) 1010315.8

(51) Int. Cl. G05B 15/02

(52) U.S. Cl. CPC G05B 15/02
USPC 700/79

(57) ABSTRACT

A machine management system, including one or more sensors arranged to take readings of one or more operating variables for a machine. Data processing equipment is arranged to receive data indicative of said operating variable readings for the machine and to analyse the received operational data to determine a probability distribution there-for. The processing equipment includes one or more modules of machine-readable code for assigning a value to one or more Stable distribution parameters in dependence on the received operational data, and a departure in the machine operation from a predetermined normal operating condition is determined from the assigned distribution parameter.

The present invention relates to the detection of an abnormality in an asset and, more particularly, an abnormality in the operation of a machine.

Data driven methods are widely used in health monitoring applications for high value assets such as, for example, engines or industrial machinery. Operational data gathered from sensors during use of such assets allows for diagnosis of existing abnormal machine behaviour or else prognosis of possible future abnormalities. Such methods are becoming key to ensuring prolonged and safe use of assets.

Known methods are used, for example, to derive features in the observed operational data for an asset which are indicative of possible future failure events for an asset or component or sub-assembly thereof.

In novelty detection, a model of normality is constructed from datasets for which the machine operation is considered to be “normal”. Accordingly, significant deviations from that model can be classified as “abnormal”. This approach is particularly well-suited for condition monitoring of high-integrity systems, in which faults are rare in comparison with long periods of normal operation. Such systems are often highly complex, with many possible modes of failure. By modelling normal system behaviour, previously-unseen, or under-represented, modes of failure may be identified.

However the potential benefits of known methods are curbed by the reliability with which such events can be modelled or predicted. Particularly in the case of high value assets—upon which a larger process, system or organisation is heavily dependent—any inaccuracy in prediction can have significant consequences. For example, the need to take a key piece of machinery offline within a power plant or the like can result in unwanted downtime for the entire process.

The gravity of such considerations is further heightened in situations where an asset is considered to be safety-critical, such as for example in the case of gas turbine engines for aircraft. Within civil aviation, there is increasing pressure for aircraft operators to achieve greater levels of efficiency, which requires accurate prediction of the possible use of aircraft engines, including the need for maintenance or overhaul work and the scheduling thereof.

However within any modelling exercise assumptions need to be made about the received data or else the operation of the asset based on previous experience and/or application of a model to trial scenarios. Thus there always exists a likelihood that an extreme event or else a combination of known operation features could occur for which the model is unable to provide an accurate diagnosis or prognosis.

Accordingly, known techniques can result in a risk of false alarms, for which a deviation from a normal operating condition has been acknowledged but for which an actual risk associated with such an abnormality is not known.

It is an aim of the present invention to provide a more effective system and method for detection of an abnormality in a machine.

According to a first aspect of the present invention, there is provided a machine abnormality detection system comprising: sensing equipment for sensing one or more operational variables of a machine; one or more processors arranged to receive data representative of said one or more operational parameters for a period of use; wherein the received data is modelled dynamically using a Stable probability distribution by assigning one or more Stable distribution parameters and the assigned parameter is used to infer whether an abnormal event has occurred.

According to a preferred embodiment, a non-Gaussian probability distribution is applied. The determined probability distribution may display greater kurtosis than that of a Gaussian distribution. The distribution may comprise a so-called heavy-tailed or long-tailed distribution.

A machine management system according to claim 1, wherein the or each Stable distribution parameter is one of an index of stability, a skewness parameter, a scale parameter and/or a location parameter.

In one embodiment, a normal operating condition is predetermined. An abnormality on the machine operation may be determined based upon a difference between the assigned value of the Stable distribution parameter and a distribution parameter value according to said normal operating condition.

A threshold difference may be predetermined. When the difference between the assigned value of the Stable distribution parameter and the normal distribution parameter value exceeds said threshold difference, an abnormal condition may be determined. The normal operating condition may be defined using a Gaussian distribution, having corresponding Gaussian distribution parameters.

Two or more Stable distribution parameters may be dynamically assigned in dependence on the received operational data. Typically four Stable distribution parameters are assigned based on the received data. Any or any combination of distribution parameters may be bounded. Accordingly Stable distribution parameters may be assigned only within certain limits or under specific exceptions. Gaussian distribution parameter values may be excluded.

The Stable distribution parameter may be an index of stability, α. An abnormal operating condition for the machine may be determined for the condition α<2.

The Stable distribution parameter determination may comprise a plurality of determination stages. An initial value estimation stage may be followed by a subsequent refinement process. The initial value of the, or each, distribution parameter may be estimated using a quantile-based method. The refinement process may comprise a regression-base procedure.

The one or more processors may be arranged to output an alert or warning signal upon determination of an abnormality in machine operation. Suitable alerting means may be arranged to display a corresponding message or other output to a display, such as a screen. Any or any combination of conventional alerting means may be used.

The system may further comprise scheduling means, such as a scheduling program arranged to manage maintenance, repair, overhaul or replacement parts for the machine or a replacement machine. The scheduling program may run on one or more processors, such as PCs and may be networked such that it can communicate with the machine abnormality detection system, for example if located remotely. The output of an abnormal operation determination from the machine abnormality detection system may result in a corresponding entry being created in the scheduling means. Such an entry may be automatically generated.

According to a second aspect of the invention, there is provided a method of determining an abnormality in the operation of a machine, comprising: receiving data indicative of operating variable readings for the machine; determining a probability distribution for said received data said distribution being from the class or family of Stable distributions, determining whether there is an abnormality in machine operation is anticipated based upon one or more parameter values defining the determined Stable distribution.

According to a third aspect of the present invention there is provided a method of predicting a machine failure event, in accordance with the second aspect.

According to a further aspect, there is provided a data carrier comprising machine-readable instructions for the control of one or more processors to perform the method of either the second or third aspect.

For conciseness, the preferable features of any one aspect have not been repeated for all aspects. However it will be appreciated that all preferable features are equally applicable to other aspects wherever it is practicable so to do.

One or more workable embodiments of the present invention are described in further detail below by way of example with reference to the accompanying drawings, of which:

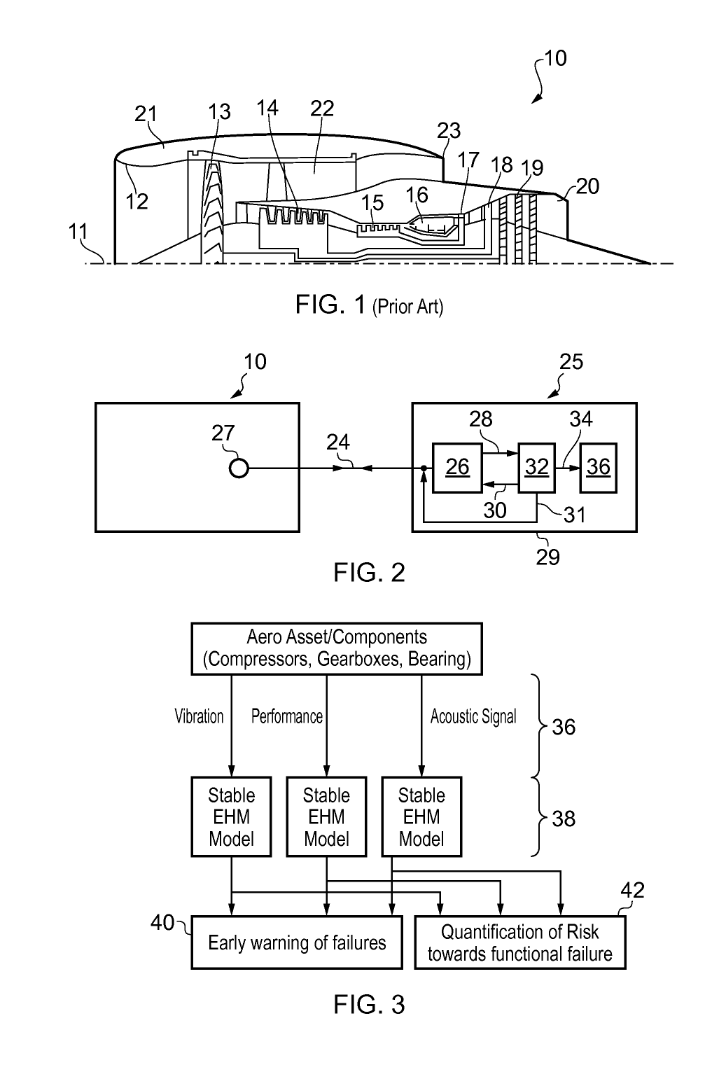

FIG. 1 shows a half section of a gas turbine engine according to the prior art;

FIG. 2 shows a top level schematic of a system according to the present invention;

FIG. 3 shows an overview of the flow of data for a process according to one embodiment of the present invention;

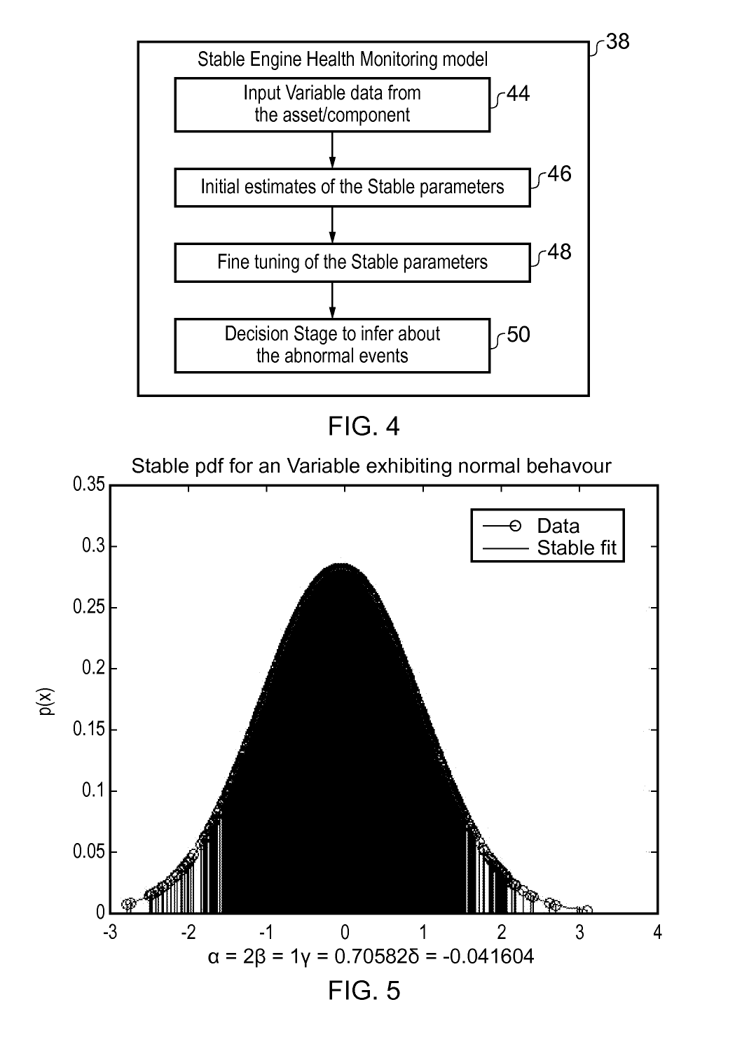

FIG. 4 shows further detail of the data processing stage of the embodiment of FIG. 3;

FIG. 5 shows an example of a stable distribution for an asset operating under a normal state of operation;

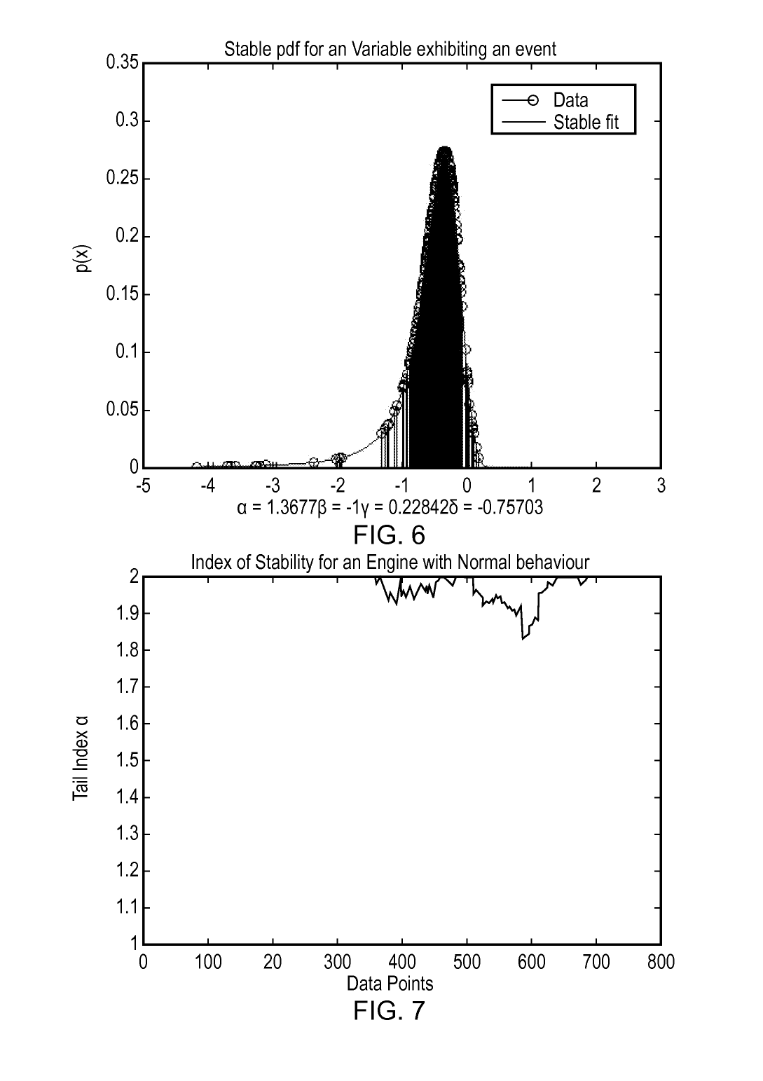

FIG. 6 shows an example of a stable distribution for an asset operating during an abnormal or unwanted event;

FIG. 7 shows a plot of index of stability for an asset operating under a normal state of operation;

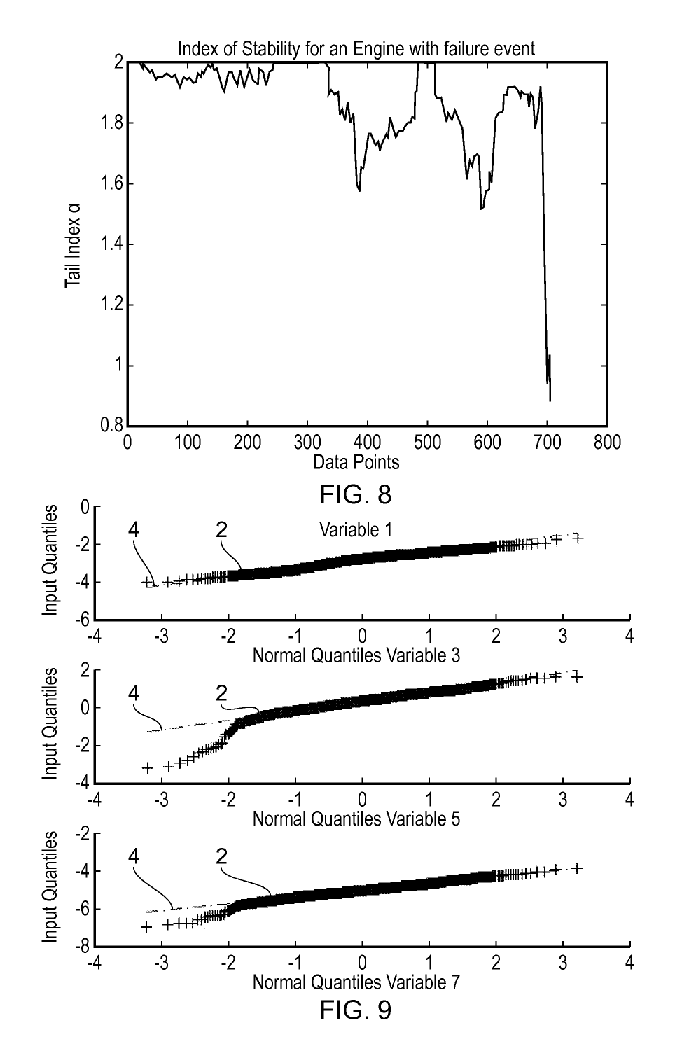

FIG. 8 shows a plot of index of stability for an asset operating under an abnormal state of operation; and,

FIG. 9 shows quantile-quantile plots for a number of variables exhibiting non-Gaussian behaviour.

With reference to FIG. 1, a ducted fan gas turbine engine generally indicated at 10 has a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and a core engine exhaust nozzle 20. A nacelle 21 generally surrounds the engine 10 and defines the intake 12, a bypass duct 22 and a bypass exhaust nozzle 23.

The gas turbine engine 10 works in a conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high, intermediate and low-pressure turbines 17, 18, 19 respectively drive the high and intermediate pressure compressors 15, 14 and the fan 13 by suitable interconnecting shafts.

Alternative gas turbine engine arrangements may comprise a two, as opposed to three, shaft arrangement and/or may provide for different bypass ratios. Other configurations known to the skilled person include open rotor designs, such as turboprop engines, or else turbojets, in which the bypass duct is removed such that all air flow passes through the core engine. The various available gas turbine engine configurations are typically adapted to suit an intended operation which may include aerospace, marine, power generation amongst other propulsion or industrial pumping applications.

Whilst the engine arrangement is described above with a degree of particularity, it is to be understood that such engines are merely examples of machines to which the present invention can be applied. Other assets to which the invention may be applied include, by way of non-exhaustive examples, other types of engines and propulsion equipment, power generation machinery, pumping equipment, machining equipment or the like. Methods are described below in relation to gas turbine engine performance data and are applicable to health monitoring of engine performance variables. Such methods can be extended to model other operational data, such as vibration data and may be applied to different in-service assets.

Traditional conditional monitoring approaches typically use an ad-hoc alerting threshold (derived using domain-based expert knowledge) to monitor the variables for abnormal events. The data-driven approach of the present invention is a useful alternative to this, in which a probabilistic model is constructed to capture the structure of the data with the aim of identifying any precursors of failures in the out-of-sample data as being “improbable” events.

Within existing data-driven equipment health monitoring (EHM) applications, it is generally assumed that the randomness or variation in a given dataset will follow a Gaussian distribution. A mixture of Gaussians is also used to model data with multiple modes in them. However the inventors have determined that the tail behaviour of distributions offers valuable information for decision support and risk management in the context of machine health monitoring. Inappropriate assumptions about the distribution of the random variables may result in underestimation of the tail mass. Analytical models used by, for example, fleet engineers based on Gaussian-based probabilistic methods have been found by the inventors to potentially fall foul of such shortcomings. This can lead to inaccurate classification of out-of-sample data.

The data from assets also exhibit asymmetry as it is possible that the asset can operate for the most part at either above or below a predetermined mean variable value. The existing models fail to account for this as the conventional Gaussian probability distribution methods consider the data to be symmetric.

It has also been determined that the equipment health data often exhibits multiple modes in the data and that those modes can each exhibit different tail decay characteristics. The state of the art approaches assume the tails decay exponentially in all modes.

Such shortcomings in asset health monitoring methods can result in a number of “false alarms”, which a monitoring system should ideally avoid.

The above-described shortcomings are exemplified with reference to FIG. 9, which shows quantile-quantile plots 2 for three engine performance parameters against the best-fit Gaussian distribution 4, shown as a dashed line in each example. If the distributions of the data are actually Gaussian, the plotted data 2 follows the dashed line 4 closely. FIG. 9 shows that the data exhibits non-Gaussian behaviour in most of the tails of the distributions for each variable.

Turning now to FIG. 2, there is illustrated schematically an apparatus 10, such as an engine, monitored by abnormality detection equipment 25 according to an example of the invention. The apparatus typically comprises a machine but may be any apparatus from which measurement can be made of a physical parameter associated with the function, operation or characteristic of the apparatus. In the example of an aero engine, a physical parameter measured by the abnormality detector may be a speed of rotation or vibration or a magnitude of movement or clearance for a moving component or subassembly of the engine, or else a pressure, force or temperature or any engine component or portion.

The detection equipment 25 includes a sensor 27 arranged to measure a specified physical operating parameter of the engine, such as a vibration speed, and to produce a data value representing the measurement of the physical operating parameter. The sensor 27 is operably connected, via a data transmission link 24, to an analysis means 29 arranged to analyse measurement data received from the sensor 27 and to conditionally indicate an abnormality in the measured operating characteristics of the engine 10 using received such measurement data.

The transmission link 24 may comprise any wired or wireless link capable of conveying data signals to the analysis means and may comprise any suitable combination of available networks and/or data storage or transfer media.

The analysis means 29 includes a data storage unit 26, which may be any suitable electronic or optical data storage apparatus suitable for retrievably storing data values (e.g. digitally) and which is arranged to receive and store therein measurement data from the sensor 27. The data storage unit is also arranged to receive data retrieval commands via a command transmission link 30 and is responsive thereto to retrieve stored measurement data specified in such a command, and to output the retrieved data via an output data transmission link 28.

A computing and/or control means 32, such as a central processor unit of a computer, or a combination of processors, or the like, is provided in the analysis means in communication with the data storage unit 26 and the sensor 27. The computing and control means 32 is arranged to generate and issue, as and when desired, data retrieval commands to the data storage unit 26 via the command transmission link connecting it to the data storage unit, and data acquisition commands to the sensor 27 via a further command transmission link (31 and 24).

The sensor 27 is responsive to such data acquisition commands to perform a specified physical parameter measurement, and to transmit the result to the data storage unit. In alternative embodiments, the sensor 27 may be arranged to perform measurements automatically or independently of the computing and control means, and to store the acquired data in a memory storage means optionally provided in the sensor to permit transfer of that data to the data storage unit 26 as a data sample set. Such measurements will typically be taken incrementally according to an implemented EHM control strategy, resulting in a data set which can be used for the same purposes as will be described below.

In the present example, the computing and control means is arranged to issue a pre-selected number (n) of successive data acquisition commands to cause the sensor to repeat successive physical parameter measurements, such that a plurality (n) of measured physical parameter values are acquired. The data storage unit is arranged to store the plurality of values as a data sample set, in which each value is individually identifiable.

In FIG. 3, there is shown a corresponding schematic illustration of how data passes through a system according to one embodiment of the invention. Sensor data 38 from the asset 10—which may comprise for example, operational data relating to the compressor, gearbox, bearing, or the like for a gas turbine engine—is fed to the processing means 32 where it is processed according to the EHM model algorthims 40. In FIG. 3, there is shown three exemplary types of data representative of readings of vibration, performance and acoustic signal respectively.

The outcome of the data processing results in the output of warning 42 of the determined future failure of a component, subassembly or other part of the asset 10 (or even the asset as a whole). Additionally or alternatively, the data processing stages may generate a quantification of the risk of, or towards, functional failure of a component, subassembly or other part of the asset 10. Either or both outputs can then be used to determine if engine inspection, maintenance or overhaul is required and to schedule such action in line with the proposed use of the asset 10 so as to minimise the impact on a desired operational plan. At this stage the outputs of one or a plurality of individual models or assessments may be combined such that multiple diagnosed or potential symptoms can be considered in determining a potential event or cause of potential failure.

In the example of an aircraft operator, maintenance work can be scheduled and one or more spare engines can be arranged and made available such that the aircraft need not be grounded for the duration of the maintenance work. Also spare parts can be arranged in advance along with any other resources required to undertake the desirous repair work. Such proactive planning has significant benefits to the efficiency with which an aircraft and fleet of aircraft can be operated. Similar benefits can be associated with any other type of high-value and/or complex asset(s).

Turning now to FIG. 4, there is shown further detail of how the sensed operational data can be processed at stage 38.

The invention introduces a new approach in machine/engine health monitoring by using Stable distributions, the definition and parameterisation of which is discussed below. These distributions are capable of modelling the asymmetry and the heavy tails in the data far better than Gaussian distributions.

If X, X₁,X₂,X₃ . . . , Xₙ are random variables that are independent and identically distributed, they are termed stable if the shape of their distribution is retained after summation; i.e., for every n,

X₁+X₂+X₃ . . . Xₙ [symbol] cₙX+dₙ (1)

where cₙ>0 and dₙ are constants and [symbol] stands for equality in distribution. The class of distributions with the above property can be termed Stable distributions. The above form as in equation (1) is termed as ‘sum stable’, because the stability is defined in a summation sense. This can also be extended into ‘multiplication stable’, ‘min-stable’, and ‘max-stable’. The latter two examples lead to extreme value distributions. The stable framework can also be extended into geometric equivalents such as geometric sum stable, multiplication stable, min stable, and max stable.

Let Xᵢ be a random variable at period t=t₀+i with a distribution function F. There exists a small probability in any period that an event can alter the probabilistic structure of the underlying process. If the time at which such event occurs is T(p), this time T(p) is assumed to be a random variable following a geometric distribution P{T(p)=k}=(1−p)^{k-1} p. The geometric sum can be defined as the accumulation of all Xᵢ's up to the event t₀+T(p). i.e.

$$G ( p ) = {\sum }_{i = 1}^{T ( p )} {X}_{i} .$$

The distribution function F of the random variable is geometric stable if there exists constants α=α(p)>0 such that αG(p) [symbol] X₁. More detailed definitions can be found in Stable Paretian Models in Finance (Rachev Svetlozar, Mittnik Stefan), Series in Financial Economics and Quantitive Analysis, John Wiley and Sons, 2000.

The Stable distribution is defined by four parameters, namely Index of stability or characteristic exponent α∉(0,2]; a skewness parameter, β∉[−1,1]; a gamma or scale parameter, γ>0; and, location parameter, δ, which constitutes a member from the set of all real numbers (δ ε [symbol] ).

The characteristic exponent α determines the rate at which the tails decay. When α=2, the stable distribution becomes a Gaussian distribution. For α<2, the decay characteristic follows a power-law. The δ parameter shifts the distribution to the left or right on the x-axis, while the γ parameter compresses or expands the distribution about δ in proportion to γ. The skewness parameter β along with the index of stability (α) determines the shape of the distribution. Often for analysis, the stable random variable X is used as a transformed variable according to (X−δ)/γ, because the transformation results in a stable distribution due to the property shown in (1).

Turning now to FIG. 4, the variable data for the asset is input or otherwise accessed at 44. Once the data is available initial estimates are made for the four parameters used to define the Stable distribution to be applied. The methods employed to estimate the values of the four parameters using a training dataset may comprise (i) the method of moments or (ii) maximum likelihood estimation.

In the embodiment described herein, a two-stage method for estimating the four parameters is employed. In this process, the initial values of the parameters are estimated firstly using a quantile-based method at 46. These initial estimates are then refined using a regression-based method at 48. described by Koutrovelis^{[7]}.

With reference to McCulloch J (Simple Consistent Estimators of Stable distribution parameters, Communications in Statistics—Stochastic Models, 15(4), 1109-1136, 1986), it can be showed that the four parameters can be estimated consistently from the pre-determined sample quantiles for α [0.6,2] and) β [−1,1]. Using the five population quantiles, x_{p, where p=}0.05, 0.25, 0.5. 0.75 and 0.95, reliable estimates of the values of the four parameters can be found. First, the functions v_{α} and v_{β} were found using the population quantiles as follows:

$${v}_{α} = \frac{{x}_{0.95} - {x}_{0.05}}{{x}_{0.75} - {x}_{0.25}} and {v}_{β} = \frac{{x}_{0.95} - {x}_{0.05} - 2 {x}_{0.5}}{{x}_{0.95} - {x}_{0.05}} .$$

A set of tables containing the values of v_{α} as a function of φ₁(α, β) and v_{α} as functions of φ₂(α, β) The functions values φ₁ and φ₂ were stored as look up tables. For an estimated v_{α}, the equivalent α and β can be obtained from the tables (reversing the relationship). Similarly

$${v}_{γ} = \frac{{x}_{0.75} - {x}_{0.25}}{γ}$$

was used and its relationship with a function Φ₃(α, β) was used to calculate γ. Using γ and functions φ₄ (α, β) and

$${v}_{δ} = \frac{δ - {x}_{0.5}}{γ} ,$$

δ was estimated.

Characteristic functions and distribution functions are discussed below with reference to stages 48 and 50 in FIG. 4. In continuous the sense, the distribution function

$$F = P [ X \leq x ] = {\int }_{- ∞}^{x} f ( y ) d y \qquad ( 2 )$$

defines the probability that a random variable (r.v.) y realises a value in the interval (−∞,x], where f(•) denotes the density function of the r.v.

The distributions can then be used to make decisions about the asset variable exceeding a certain value with a degree of confidence using probability measures. This means that it is preferable to estimate the distributions in closed form. Among the Stable family of distributions, only three types of distributions have closed form expression densities: the Gaussian (α=2), the Levy (α=0.5), and the Cauchy (α=1). For other values of α, the densities and distribution functions can be estimated using the characteristic function approach.

A characteristic function for a random variable X={x₁,x₂ . . . xₙ} can be defined as

$${φ}_{n} ( t ) = \frac{1}{n} {\sum }_{j = 1}^{n} exp ( i {tx}_{j} ) \qquad ( 3 )$$

It is possible to obtain distribution functions from the characteristic function either using the inversion theorem or integral transforms. Stable laws can be defined by their characterisation equation

φ(t)=exp{iδt−|γt|^{α}[1+iβ sgn(t)ω(t,α)]} (4)

where ω(t,α)=tan(πα/2) for α≠1 and ω(t,α)=(2/π)log|t| for α=1.

It can be showed that if we take z=log(−log|φ(t)|²)=log(2γ^{α})+α log(t), z depends only on α and γ. From the above expression, it is possible to estimate the parameters using a two step procedure.

In the first step, α and γ are estimated by regressing log(−log|φ(t)|²) onto w=log|t| in the model log(2γ^{α})+αwₖ+εₖ. Here k=1,2,3 . . . K denotes appropriate set of points chosen from a lookup table for various sample sizes N and α•εₖ denotes the regression error term. The characteristic function φ(t) and w are evaluated at points tₖ=πk/25.

Similarly β and δ can be estimated by regressing arctan(img(φ(u))/real(φ(u))) onto u and sign(u)|u|^{α} in the model δuₗ−βγ^{α} tan(πα/2)sgn(uₗ)|uₗ|^{α}+εₗ. Here l=1,2,3 . . . L denotes appropriate set of points chosen using a lookup table for various sample sizes N and α•εₗ denotes the regression error term. The arctan(•) term and regression model are evaluated at points uₗ=πl/50.

Turning now to the issue of computing stable densities, many parameterisations have been proposed in the literature to compute stable densities using characteristic functions similar to that shown in equation (4). Once such parameterisation, called Zolotarev's (M) parameterisation, is used for the purposes of the present embodiment. According to this method, the characteristic function takes the form

$$E ( exp i tX ) = \{ \begin{matrix}exp \{ - {\vert t \vert}^{α} [ 1 + β ( sign ( t ) ) ( tan \frac{π α}{2} ) ( {\vert t \vert}^{1 - α} - 1 ) ] \} α \neq 1 \\ exp \{ - {\vert t \vert}^{α} [ 1 + β ( sign ( t ) ) ( \frac{2}{π} ) ( ln \vert t \vert ) ] \} α = 1\end{matrix} \qquad ( 5 )$$

The above parameterisation ensures the characteristic function is jointly continuous in all four parameters, and that the densities and the distributions derived from it remain continuous. Zolotarev's integral formulae were used to compute the density f(x;θ) and distribution function F(x;θ) of a random variable with a characteristic function of the form as given in equation (5), where θ={α,β,γ,δ}. Reference is made to the definitions below:

$$\begin{matrix}ζ = \{ \begin{matrix}- β tan \frac{π α}{2} & α \neq 1 \\ 0 & α = 1 ,\end{matrix} & \\ {θ}_{0} = \{ \begin{matrix}\frac{1}{α} arctan ( β tan \frac{πα}{2} ) & α \neq 1 \\ \frac{π}{2} & α = 1\end{matrix} & \\ c = \{ \begin{matrix}\frac{1}{π} ( \frac{π}{2} - {θ}_{0} ) & α < 1 \\ 0 & α = 1 \\ 1 & α > 1\end{matrix} & \\ φ ( θ ) = \{ \begin{matrix}\begin{matrix}{cos ( {αθ}_{0} )}^{\frac{1}{α - 1}} {( \frac{cos θ}{sin α ( {θ}_{0} + θ )} )}^{\frac{α}{α - 1}} \\ \frac{cos ( α {θ}_{0} + ( α - 1 ) θ )}{cos θ}\end{matrix} & α \neq 1 \\ \frac{2}{π} ( \frac{0.5 π + β θ}{cos θ} ) exp ( \frac{1}{β} ( \frac{π}{2} + β θ ) tan θ ) & \begin{matrix}α = 1 , \\ β \neq 0\end{matrix}\end{matrix} & \end{matrix}$$

Compared to equation (5), expressing the characteristic function φ(θ) as a function of alternative skewness θ₀, makes the calculation direct.

The densities and distributions are given as follows.

For α≠1 and x>ζ

$$\begin{matrix}f ( x ; θ ) = \frac{{α ( x - ζ )}^{\frac{1}{α - 1}}}{π \vert α - 1 \vert} {\int }_{- {θ}_{0}}^{\frac{π}{2}} φ ( θ ) exp ( - {x ( x - ζ )}^{\frac{α}{α - 1}} φ ( θ ) ) d θ & ( 6 ) \\ F ( x ; θ ) = {c}_{1} ( α , β ) + \frac{sign ( 1 - α )}{π} {\int }_{- {θ}_{0}}^{\frac{π}{2}} exp ( - {x ( x - ζ )}^{\frac{α}{α - 1}} φ ( θ ) ) d θ & ( 7 )\end{matrix}$$

For α≠1 and x=γ

$$\begin{matrix}f ( x ; θ ) = \frac{Γ ( 1 + \frac{1}{α} ) ( cos {θ}_{0} )}{{π ( 1 + {γ}^{2} )}^{( 1 / 2 α )}} & ( 8 ) \\ F ( x ; θ ) = \frac{1}{π} ( \frac{π}{2} - {θ}_{0} ) & ( 9 )\end{matrix}$$

To monitor the engine for the purposes of this embodiment, variables describing the aero asset operational behaviour are taken and Stable distributions are fitted to the observed data. The deviation away from a normal behaviour is quantified by the index of stability or tail index. The behaviour of the fit model parameters are then used in decision making about the asset behaviour.

FIGS. 5 and 6 show that the Stable family of distributions is able to fit the heavy tails in the data more closely than the Gaussian distribution. The departure from Gaussianity is also shown in Table 1, below. Table 1 indicates the Stable distribution model parameters for eight different engine performance parameters where it may be seen that α<2 (recalling that α=2 for Gaussianity).

TABLE 1
estimated Stable parameters

| Variable | Alpha (α) | Beta (β) | Gamma (γ) | Delta (δ) |
|---|---|---|---|---|
| 1 | 2 | −1 | 0.3039 | −2.8791 |
| 2 | 2 | −1 | 0.6630 | −4.329 |
| 3 | 1.7333 | −0.6461 | 0.3235 | 0.2464 |
| 4 | 1.8536 | −1 | 0.1466 | −1.8655 |
| 5 | 1.8274 | −0.92422 | 0.2558 | −5.0187 |
| 6 | 1.9618 | −1 | 0.1695 | −0.8034 |
| 7 | 2 | −1 | 1.5353 | 70.3441 |
| 8 | 2 | −1 | 4.0646 | 119.5177 |

In a second test (the results of which are shown in FIGS. 7 and 8), the time-variation of α is shown during periods of “normal” operation (FIG. 7) and during a period in which asset failure occurs (FIG. 8). The event is clearly identified by rapid changes in the value of α during the period of abnormal asset condition which may be seen towards the right hand side of FIG. 8.

In most practical applications, the data does not follow Gaussian distribution, but instead contains heavy tail and peaky distribution with excessive kurtosis. The state of the art methods can't model such data accurately.

Accordingly the present invention provides for a new principled approach for modelling operational data distributions, in which the Gaussian distribution, used to describe a normal behaviour of engine, becomes a special case of the more widely applicable Stable distributions. Hence the model is able to quantify both normal behaviour of the aero asset data and the deviation from normality effectively.

As more data is observed from the engine, the model can adjust itself to accommodate the tail thickness and any observed asymmetry in the data. Accordingly the Stable parameters defined above can be adjusted in accordance with suitable implementing algorithms to accommodate data distributions more accurately, and thus derive information from tail events more effectively.

Quantifying the deviation away from Gaussianity is also an important aspect of the proposed prognostic solution to estimate the impending risk. The above-described techniques allow for a model that can estimate this for asset health monitoring.

Furthermore vibration and/or performance parameters obtained, for example, from the aircraft engine using Stable parameters in a manner where each point corresponding to an engine flight or cycle. Thus the evolution of Stable parameters through time can also indicate point by point behaviour of the Index of Stability as shown in FIGS. 7 and 8. The Index of Stability enables us to have an EHM system that can monitor the engine behaviour in a quantitative manner by the deviation from a threshold value required for normality (for example the value of 2 in FIGS. 7 and 8). Such deviations can be used to infer a path towards a future abnormality, such as a failure event.

The range of applications for the present invention is diverse and, whilst it finds particular applications in complex, high value and/or safety-critical machinery, it could potentially include any other types of industrial or vehicular machinery. Additionally the invention could encompass processes using such machinery or assets such as manufacturing processes, power generation, chemical, nuclear, thermal or mechanical processing and/or raw material extraction or harvesting, where early detection of the abnormal events and quantifying the path towards catastrophic failures are of high importance.

1. A machine management system, comprising:
one or more sensors arranged to take readings of one or more operating variables for a machine;
data processing equipment arranged to receive data indicative of said operating variable readings for the machine and analyse the received operational data to determine a probability distribution there-for,
wherein the processing equipment comprises one or more modules of machine-readable code for assigning a value to one or more Stable distribution parameters in dependence on the received operational data, and a departure in the machine operation from a predetermined normal operating condition is determined from the assigned distribution parameter.

2. A machine management system according to claim 1, wherein the or each Stable distribution parameter is one of an index of stability, a skewness parameter, a scale parameter and a location parameter.

3. A machine management system according to claim 1, wherein a normal operating condition is defined using a Gaussian distribution and the departure in machine operation from the normal operating condition is based upon a difference between the assigned value of the Stable distribution parameter and a distribution parameter value according to said Gaussian distribution.

4. A machine management system according to claim 1, wherein the Stable distribution parameter defines a distribution having greater kurtosis than that of a Gaussian distribution.

5. A machine management system according to claim 1, wherein the Stable distribution parameter accommodates asymmetric behaviour in the data.

6. A machine management system according to claim 1, wherein a threshold parameter value is predetermined and an abnormality in machine operation is determined when said assigned distribution parameter meets or exceeds said threshold value.

7. A machine management system according to claim 1, wherein four Stable distribution parameters are assigned in dependence on the received operational data.

8. A machine management system according to claim 1, wherein the Stable distribution parameter is an index of stability, α and a departure in the machine operation from a predetermined normal operating condition is determined for the condition α<2.

9. A machine management system according to claim 1, wherein an initial value of the, or each, Stable distribution parameter is estimated using a quantile-based method.

10. A machine management system according to claim 9, wherein said initial value estimation is subsequently refined using a regression-based method.

11. A machine management system according to claim 1, comprising alerting means, wherein upon determination of a departure in the machine operation from a predetermined normal operating condition, the processing equipment outputs an alert signal via said alerting means.

12. A machine management system according to claim 1, comprising a scheduler for scheduling inspection, maintenance, or overhaul work in dependence on output of a signal from said processing equipment indicative of the determination of a departure from said normal operating condition.

13. A method of determining an abnormality in the operation of a machine, comprising:
receiving data indicative of operating variable readings for the machine;
analysing the received operational data to determine a probability distribution there-for,
approximating the probability distribution by way of a Stable distribution by assigning a value to a plurality of Stable distribution parameters in dependence on the received operational data, and
determining a departure in the machine operation from a predetermined normal operating condition based upon the assigned distribution parameter value.

14. A method according to claim 13, wherein the determination of an abnormal operating condition comprises comparing the assigned distribution parameter value to a predetermined normal parameter value.

15. A data carrier comprising machine-readable instructions for the control of one or more processors to perform the method of claim 13.
